(19) United States
(12) Patent Application Publication
(10) Pub. No.: US 2022/0282391 A1
(43) Pub. Date: Sep. 8, 2022

(54) ADDITIVE HEAT EXCHANGER AND METHOD OF FORMING

(71) Applicant: Unison Industries, LLC, Jacksonville, FL (US)

(72) Inventors: Gordon Tajiri, Waynesville, OH (US); Dattu GV Jonnalagadda, Ponnur (IN); Michael Ralph Storage, Beavercreek, OH (US); Emily Marie Phelps, Xenia, OH (US); Jason Levi Burdette, Dayton, OH (US)

(21) Appl. No.: 17/192,027

(22) Filed: Mar. 4, 2021

(51) Int. Cl. C25D 5/00; F28G 9/00; C25D 1/02; C25D 5/34; C25D 5/48

(52) U.S. Cl. CPC C25D 5/611; F28G 9/00; C25D 1/02; C25D 5/34; C25D 5/48

(57) ABSTRACT

A method of electroforming can be used to prepare a heat exchanger by electroforming the heat exchanger on a mandrel having a smooth and conductive surface. The mandrel is in the shape of at least part of the heat exchanger, and is removed from the electroformed heat exchanger.

### TECHNICAL FIELD

The disclosure generally relates to a heat exchanger, more specifically to a heat exchanger with more than one cooling pathway for a turbine engine which utilizes a method to improve surface finish and wall thickness control during electrodeposition.

### BACKGROUND OF THE INVENTION

Contemporary engines, such as those used in aircraft, produce substantial amounts of heat that must be transferred away from the engine in one way or another. Heat exchangers provide a way to transfer heat away from such engines. For example, heat exchangers can be arranged in a ring about a portion of a turbine engine.

Oil can be used to dissipate heat from engine components, such as engine bearings, electrical generators, and the like. Heat is typically transferred from the oil to air by air-cooled oil coolers, and more particularly, surface air-cooled oil cooler systems to maintain oil temperatures at a desired range from approximately 100° F. to 300° F. In many instances, an environment can be as low as −65° F.

### BRIEF DESCRIPTION OF THE INVENTION

Aspects and advantages of the invention will be set forth in part in the following description, or may be evident from the description, or may be learned through practice of the invention.

In one aspect, the present disclosure relates to a method of electroforming a heat exchanger, the method comprising: polishing a conductive surface of a mandrel shaped as at least a portion of the heat exchanger; electroforming the heat exchanger onto the conductive surface of the mandrel; and removing the mandrel from the electroformed heat exchanger.

In yet another aspect, the present disclosure relates to a method of electroforming a component, the method comprising: polishing a conductive surface of a mandrel shaped as the component; and electroforming the component onto the conductive surface of the mandrel; and removing the mandrel from the component to expose a new surface of the component previously bordered by the mandrel; wherein the new surface has a surface roughness (rms) that is less than 32 microinches resultant of polishing the conductive surface before electroforming the component.

In yet another aspect, the present disclosure relates to a method of forming a heat exchanger, the method comprising: providing a removable mandrel defining the shape of the heat exchanger; coating surfaces of the mandrel in a conductive coating to define a cathode; electroforming the heat exchanger onto the cathode to include wall thicknesses that are 3-4 mils; removing the mandrel from the electroformed heat exchanger; and treating the electroformed heat exchanger to remove any remaining conductive coating from the electroformed heat exchanger.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

In the drawings:

FIG. 1 is a schematic illustration of an electrodeposition bath with a mandrel in the form of a component, with a portion of the component cut away.

FIG. 2 is a process flow diagram illustrating a method of electroforming a component, such as a heat exchanger.

FIG. 3 is a perspective view of a heat exchanger formed by the process illustrated in FIG. 2 having manifolds connected by a plurality of tubes in accordance with various aspects described herein.

FIG. 4 is a schematic cross-sectional view of a tube from FIG. 3 taken along line IV-IV of FIG. 3, in accordance with various aspects described herein.

FIG. 5 is a top view of the heat exchanger of FIG. 3.

FIG. 6 is a schematic cross-sectional view of a portion of the heat exchanger from FIG. 3 including portions of the manifolds and connecting tubes taken along line VI-VI in FIG. 3, in accordance with various aspects described herein.

FIG. 7 is a perspective partial cut-away view of a monolithic heat exchanger with intertwined, furcated tubes, in accordance with various aspects described herein.

FIG. 8 is a perspective view of a monolithic heat exchanger in the form of a set of nested spirals, in accordance with various aspects described herein.

### DETAILED DESCRIPTION OF THE EMBODIMENTS

The present disclosure relates to a heat exchanger having meshed pathways for cooling fluids. More specifically, the disclosure relates to a method of electroforming a component which has an improved surface finish and improved wall thickness control, which can provide for improved heat transfer and less turbulation for fluids passing along the heat exchanger. For purposes of illustration, the aspects of the disclosure discussed herein will be described with a mandrel used during an electroforming process. It will be understood, however, that the disclosure as discussed herein is not so limited and may have general applicability within forms utilized for electroforming processes.

All directional references (e.g., radial, upper, lower, upward, downward, left, right, lateral, front, back, top, bottom, above, below, vertical, horizontal, clockwise, counterclockwise) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto can vary. As used herein, a “set” can include any number of elements, including only one. “Integral monolithic body” or “monolithic body” as used herein means a single body that is a single, non-separable piece, or formed as a single unitary piece at manufacture, as opposed to being formed by combining separate elements into one during manufacture.

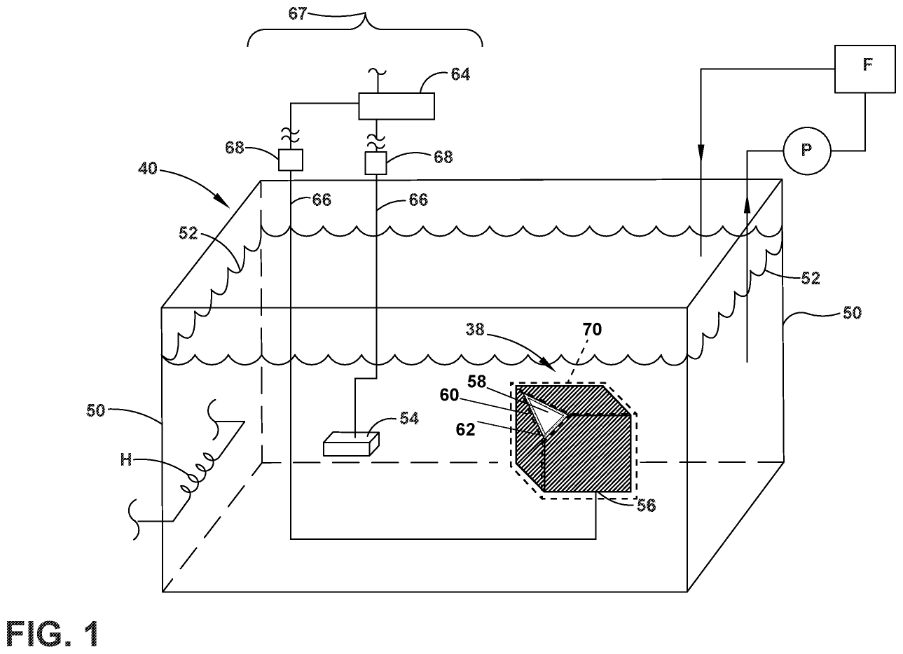

A system for carrying out an electroforming process for forming a metallic component 38 (shown in dashed line) is illustrated by way of an electrodeposition bath 40 in FIG. 1. An exemplary bath tank 50 carries a conductive electrolytic fluid solution 52. The electrolytic fluid solution 52, in one non-limiting example, can include aluminum alloy carrying alloying metal ions. In one alternative, non-limiting example, the electrolytic fluid solution 52 can include a nickel alloy carrying alloying metal ions.

An anode 54 spaced from a cathode 56 is provided in the bath tank 50. The anode 54 can be a sacrificial anode or an inert anode. While one anode 54 is shown, it should be understood that the bath tank 50 can include any number of anodes 54 as desired. The cathode 56 can be a mandrel 58 coated in an electrically conductive material 62, including, by way of non-limiting examples, copper, silver, or nickel. It is further contemplated that a spray, painting, coating, or similar treatment with a conductive material 62 can be provided to the mandrel 58 to facilitate formation of the cathode 56. In addition, while illustrated as one cathode 56, it should be appreciated that one or more cathodes are contemplated for use in the bath tank 50.

The mandrel 58 defines a body 60 formed from, by way of non-limiting example, a reclaimable material. The body 60 can be made of a reclaimable material that can be collected after an electroforming process and reused as another body in another electroforming process. Suitable reclaimable materials can include waxes, plastics, polymer foams, metals, or deformable materials, such as those materials that are collectible via melting or leaching in non-limiting examples. After completion of the electroforming process, the body 60 can be reclaimed from the electroformed component, such as through heating and melting of the body 60 at heightened temperatures, to reclaim the structural material. In this way, material waste is reduced.

A controller 64, which can include a power supply, can be electrically coupled to the anode 54 and the cathode 56 by electrical conduits 66 to form a circuit 67 via the electrolytic fluid solution 52. Optionally, a switch 68 or sub-controller can be included along the electrical conduits 66, and can be positioned between the controller 64 and the anodes 54 and cathode 56. During operation, a current can be supplied from the anode 54 to the cathode 56 via the electrolytic fluid solution 52 to electroform a monolithic metallic component 38 at the mandrel 58. During supply of the current, the metal, such as aluminum, iron, cobalt, or nickel, in non-limiting examples, from the electrolytic fluid solution 52 forms a metallic layer 70 over the mandrel 58. In a non-limiting example, the monolithic metallic component 38 can be a heat exchanger 100.

A pump (P) and filter (F) can be utilized to filter and chemically maintain the electrolytic fluid solution 52 at a particular ion concentration, or to remove any foreign matter. The filter (F) can include, by way of non-limiting example, a chemical filtering media. A heater (H) is provided to regulate a temperature of the electrodeposition bath 40. In non-limiting examples, the heater (H) can be disposed within the bath tank 50 or proximate the bath tank 50 exterior to the bath tank 50. Alternatively, the heater (H) can be in fluid communication with the pump (P) to heat the electrolytic fluid solution 52 as it is pumped by the pump (P).

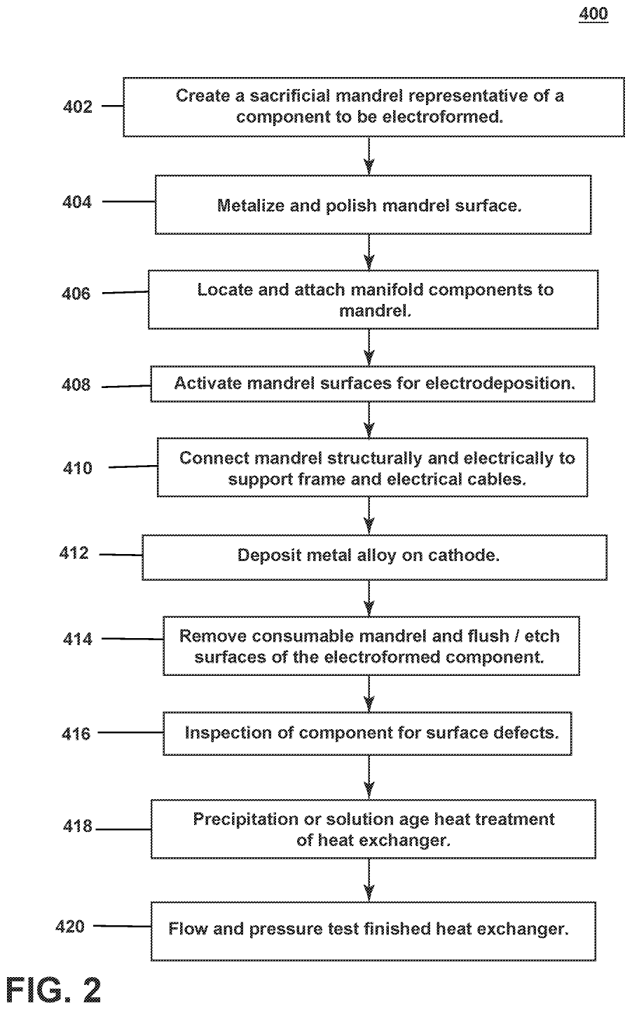

FIG. 2 illustrates a process 400 for forming the metallic component 38. The process 400 is provided for illustrative purposes and may proceed in a different logical order or additional or intervening steps may be included, unless otherwise noted. While the process 400 is described in the context of forming the heat exchanger by electrodeposition on a mandrel, the process 400 may be used in a similar manner to form other types of bodies using other suitable forms.

The process 400 begins at 402 with generating the mandrel 58. The mandrel 58 can be formed of wax or plastic, for example, or other consumable materials. The mandrel defines the shape of the heat exchanger 100. In one non-limiting example, the mandrel 58 can be formed by additive manufacturing or in another non-limiting example, by injection molding. The mandrel 58 can be removable from the finished electroformed component, and can be made of a conductive or a non-conductive material. At 404, the mandrel 58 is metalized with electrically conductive material 62 to provide an electrically conductive surface on the mandrel 58. Upon metalizing, the metalized mandrel 58 acts as the cathode in the electrodeposition bath. If the mandrel 58 is formed from a conductive material, the metalizing step is may not be needed, while it is contemplated that a metal mandrel can also be treated with an additional conductive surface to form the cathode.

Further at 404, the conductive surface of the mandrel 58 is polished such that the surface roughness (rms) is less than 32 microinches (0.81 micrometer, Ra=29 microinches), where rms is calculated as the root mean square of the surface of the mandrel 58 according to Equation 1 as defined in ASME B46.1. Rms (R_{q} in Eq 1) is the root mean square average of the profile height deviations from the mean line, recorded within the evaluation length (L), where Z(X) is a profile height function. In another example, the surface roughness can be less than 30 microinches.

$$Rq = {[ ( \frac{1}{L} ) {\int }_{0}^{L} {Z ( x )}^{2} dx ]}^{1 / 2} \qquad ( 1 )$$

Alternatively, the surface roughness can be calculated as Ra (Eq 2), the arithmetic average of the absolute values of the profile height deviations from the mean line, recorded within the evaluation length.

$$Ra = [ \frac{1}{L} {\int }_{0}^{L} \vert Z ( x ) \vert dx ] \qquad ( 2 )$$

Additionally, it is contemplated that the surface roughness rms can be less than 100 microinches (2.5 micrometers, Ra=91 microinches). Optionally, the surface roughness rms can be between 10-50 microinches (0.25-1.3 micrometers, Ra=9 to 45 microinches) or between 20-30 microinches (0.51-0.76 micrometers, Ra=18 to 27 microinches), in additional non-limiting examples. Smoothing and polishing or buffing of the conductive material 62 on the surface of the mandrel 58 allows the surface roughness rms of the heat exchanger 100 to be less than about 30 microinches (0.51 micrometers, Ra=27 microinches). It should be appreciated that a smoother surface, such as that resultant from polishing the mandrel 58, can result in a smoother surface for the completed electroformed component after removal of the mandrel 58. The electrodeposition parameters can be varied to achieve surface roughness leveling of the mandrel 58 such that the surface roughness is less than 30 microinches before smoothing. Exemplary means of smoothing the metalized mandrel 58 include, but are not limited to, electropolishing, electrochemical polishing, chemical polishing such as acetone vapor polishing, manual polishing or using a polish/grit blast, or other methods of surface polishing that are known in the art.

At 406, additional components required in forming the heat exchanger can be added to the mandrel 58. In one example, manifold components can be formed as part of the mandrel, such as by attaching manifold components to the mandrel, while it is contemplated that the manifolds are metal and are machined, then later joined to the mandrel 58 during the electrodeposition. It is further contemplated that the manifold components or other added components can be formed as a part of the mandrel 58 of step 402 above. Similarly, it is also contemplated that the mandrel for the manifolds can also be metalized to prepare for electrodeposition.

At 408, the surface of the metalized mandrel 58 is activated for electrodeposition. In this step, the surface is treated to remove oxides or other contaminants that may interfere with the electrodeposition process. This step, in addition to the polishing of the mandrel 58, creates a more favorable or more ideal surface for electrodeposition, as opposed to an untreated mandrel.

At 410, optionally, the metalized mandrel 58 can be connected structurally to a support frame to suspend the mandrel 58 in the electrodeposition bath. Similarly, the cathode mandrel, being metalized, can be electrically connected to the remainder of the system to complete the electrical circuit in the bath required for the electroforming process. In one example, the mandrel 58 is connected electrically to cables for use in the electrodeposition bath.

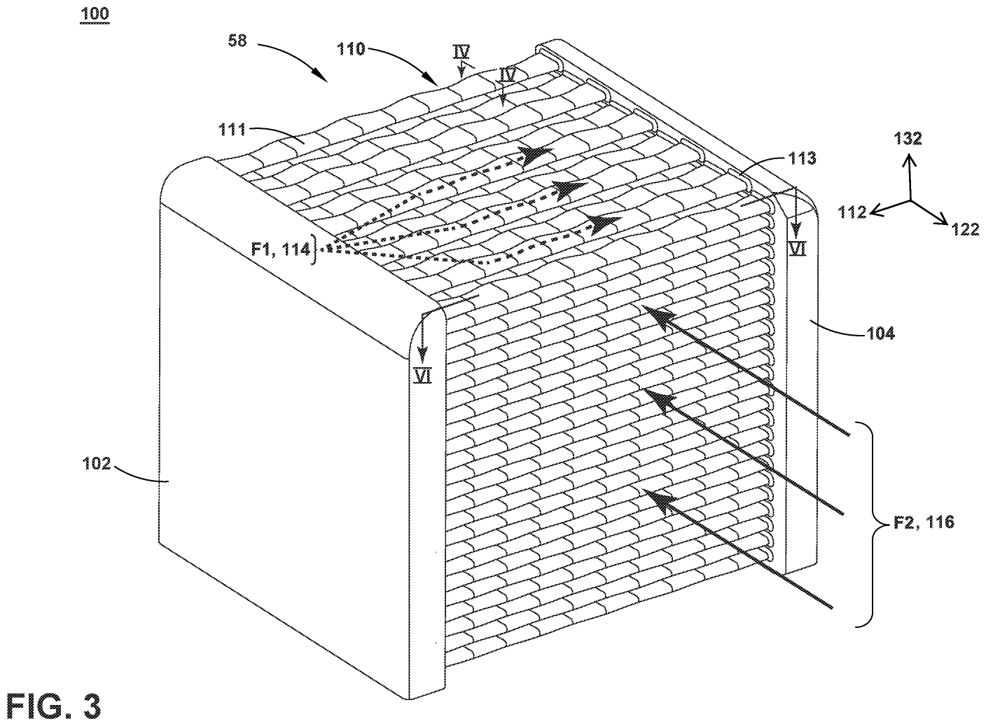

The electrodeposition of the component on the metalized mandrel 58 begins at 412. A metallic layer 70 is deposited on the cathodic metalized mandrel 58 to create the heat exchanger 100. A set of tubes defining at least a portion of the heat exchanger, such as the tubes 110 of FIG. 3, discussed below, are integrally and unitarily formed with the manifolds during deposition to form a unitary, monolithic heat exchanger component. The metallic layer deposited can be a metal alloy and can include a wall thicknesses of about 3 to 4 mils (0.007 to 0.01 centimeters), for example, where one mil is equal to one thousandth of an inch. It is further contemplated that bath parameters are controlled to produce a desired surface morphology, such as bath temperature or based upon metal type or concentration in the electrolytic bath fluid. The wall thickness of about 3 to 4 mils (0.007 to 0.01 centimeters) that is achieved by this method is less than that typically achieved by laser-based additive methods, which, for comparison, are typically 12 mils (0.03 centimeters). The reduction in wall thickness improves heat transfer locally, while also reducing component weight. Furthermore, a porosity (or pore size) of the metallic layer 70 formed by the electrodeposition is about 50 microinches (1.3 micrometers). For comparison, the porosity of surfaces formed by laser-based additive methods is typically 20-40E-03 in (5.1E-02-10E-02 centimeters), which is orders of magnitude larger than that of the metallic layer formed by the method described herein.

At 414, the consumable material making up the mandrel 58 is removed from the electroformed heat exchanger 100 exposing a new inner surface, or a revealed surface 150. In one non-limiting example, an oven bake-out process can be used, while any suitable removal process is contemplated, which can vary based upon the particular mandrel material. Further, treatment of the electroformed heat exchanger component includes flushing with an etchant or other solvent to remove any remaining conductive material 62 from the revealed surface 150 of the electroformed heat exchanger 100. Treatment of the revealed surface 150 can further include alternative means of removing conductive material 62 such as a polish/grit blast. After removal of the mandrel and flushing with the etchant, the final surface roughness rms for the heat exchanger 100 can be 20-30 microinches (0.51-0.76 micrometers, Ra=18 to 27 microinches). For comparison, surface roughness rms of an article formed by laser-based additive methods typically falls between 60 to100 microinches (1.5 to 2.5 micrometers, Ra=54 to 91 microinches).

Optional final steps 416-420 include a visual or other type of inspection of the heat exchanger surface. Examples of inspections can include a fluorescence penetration inspection for cracks or flaws, a precipitation aged heat treatment, and a flow and pressure test in non-limiting examples.

An additional contemplated step can include a post-polishing action in addition to the first polishing. More specifically, the initial polishing of the mandrel 58 can provide for decreasing a roughness of the mandrel 58 to about 30 microinches or less. Additional polishing of the final heat exchanger can further smooth the surfaces, such as reducing the roughness by about 50%, such that a final surface roughness after the post-polishing can be between 10-15 microinches. Such a small roughness can provide for improved flow efficiency and decreased pressure losses. Furthermore, the smooth surface can provide for utilizing thinner walls than otherwise possible, such that overall component weight can be decreased, which can improve overall system efficiency.

An additive manufacturing process using electrodeposition is disclosed to create a monolithic, unitary, high-temperature compact heat exchanger having fluid conduits integrated with manifold housings. A consumable mandrel is used to create the conductive deposition surface and to configure the fluid connection ports. The fluid conduits are directly integrated with manifolds at the fluid connection ports during the electrodeposition process, eliminating the need for brazing or mechanical crimping to connect the conduits to the manifolds. The mandrel is subsequently removed after metal deposition and a flush with an etchant can be used to remove the conductive deposition surface from the internal surfaces of the heat exchanger.

Advantageously, the process described herein allows the electroformed component to be directly connected structurally to and integrated with manifolds during the electrodeposition process, eliminating the need for mechanical crimping, brazing or other metal joining processes. Furthermore, this method provides walls that are about 3 to 4-fold thinner than walls prepared by traditional laser-based or electroforming additive methods. The thinner walls of the component provided by this method promote heat transfer, increasing efficiency and effectiveness of the heat exchanger, as well as decreasing the overall weight of the component. As this method requires less material, costs of production are decreased. The smoothing treatment of the mandrel in preparation for electrodeposition results in the component having a surface that is significantly smoother (e.g., about 3-fold lower surface roughness) as compared to an untreated, rough mandrel 58 is used. The improved smoothness of the component surface reduces the hydraulic loss during use of the final article, as well as reduced turbulence, aerodynamic drag, or other inefficiencies resultant of an unsmoothed surface. Furthermore, the method provides for generating a component that has a decreased porosity. The decreased porosity afforded by the method enhances the effective thermal conductivity as well as increases the knockdown strength, which combats high cycle fatigue. Overall, this manufacturing process simplification reduces time, cost, and defects, and can provide for an overall improvement in the final product, such as efficiency of a heat exchanger, as compared with that of a similar component formed by a different method.

As shown in detail in FIG. 3, the mandrel 58 as described above and utilized in the process 400 can be in the form of a heat exchanger 100 that includes a first manifold 102, a second manifold 104, and a set of tubes 110 that extends between the first manifold 102 and the second manifold 104 in a longitudinal or first direction 112. The first manifold 102 and the second manifold 104 are fluidly coupled by the set of tubes 110 which join to the first and second manifolds 102, 104 at fluid connection fittings 113, providing a conduit or fluid passage F1 for internal coolant flow between the first manifold 102 and the second manifold 104. In an aspect, the first manifold 102, the second manifold 104, and the set of tubes 110 are formed as a monolithic, unitary body. It should be appreciated that the fluid connection fittings 113 need not be separate or additional elements, but can merely be formed as a portion of the set of tubes 110 that meets the particular manifold 102, 104. It is further contemplated that fittings 113 need not be included with the heat exchanger 100.

The set of tubes 110 is arranged such that the tubes 111 are organized in rows in an axial or second direction 122 and stacked in a third direction 132, where the stacks of rows are either aligned or staggered from front to rear of the heat exchanger 100. The space between each tube 111 of the set of tubes 110 defines a flow path F2 from the front towards the rear of the heat exchanger 100. Together, the fluid passage F1 and the flow path F2 allow heat exchange between a first fluid 114 passing through the interior of the set of tubes 110 and a second fluid 116 passing along the flow path F2 over the outside surface of the set of tubes 110.

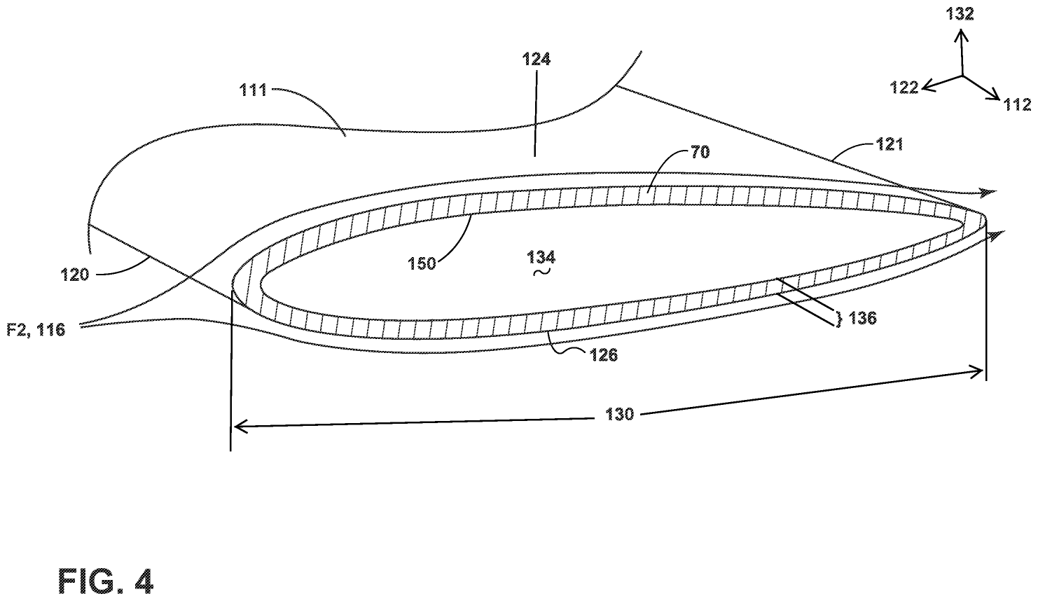

Turning now to FIG. 4, a cross-sectional view along section line IV in FIG. 3, each tube 111 has an airfoil or teardrop shape. It will be understood that this disclosure includes, but is not limited to asymmetric, semisymmetric and symmetric teardrop shapes and airfoil shapes such as laminar flow, circular arc, clark “y”, double wedge, early, later, flat bottom, under-camber, teardrop, cambered, and supercritical airfoil shapes, and is not limited to the shape shown in FIG. 3. Furthermore, each tube 111 has a leading edge 120 and a trailing edge 121 defining the axial or second direction 122 therebetween. A top surface 124 and a bottom surface 126 are further included in each tube 111, defining a third direction 132 perpendicular to both the first direction 112 and the second direction 122. An axial cross-sectional area 134 of the tube 111 is thus bounded by the leading edge 120, the trailing edge 121, the top surface 124 and the bottom surface 126.

The set of tubes 110 comprises a metallic layer 70 having a wall thickness 136 that is, in one non-limiting example, 3 to 4 mil (0.003 to 0.004 inches; 0.007 to 0.01 centimeters). The wall thickness 136 is sufficient for the heat exchanger 100 to be self-supporting during operation, and limits the amount of materials required during manufacturing. Furthermore, the wall thickness 136 allows the overall weight of the heat exchanger to be reduced in comparison to traditional heat exchangers with traditional wall thicknesses.

The leading edge 120 of each of the set of tubes 110 encounters the second fluid 116 entering the heat exchanger 100 while following flow path F2 in the axial direction 122. The flow path F2 is across the outer surface of the elongated teardrop-shaped set of tubes 110 which has an increased surface area for improved heat transfer. Further, the pressure drop across the set of tubes 110 is minimized by the airfoil shape which reduces the frontal profile and minimizes the drag across the top surface 124 and bottom surface 126 of the set of tubes 110, as well as benefits from improved flow attachment to the surfaces, which improves overall heat transfer. The airfoil profile and reduces the onset of early vortex shedding by moving the flow towards the trailing edge 121 with the improved attachment along the airfoil profile.

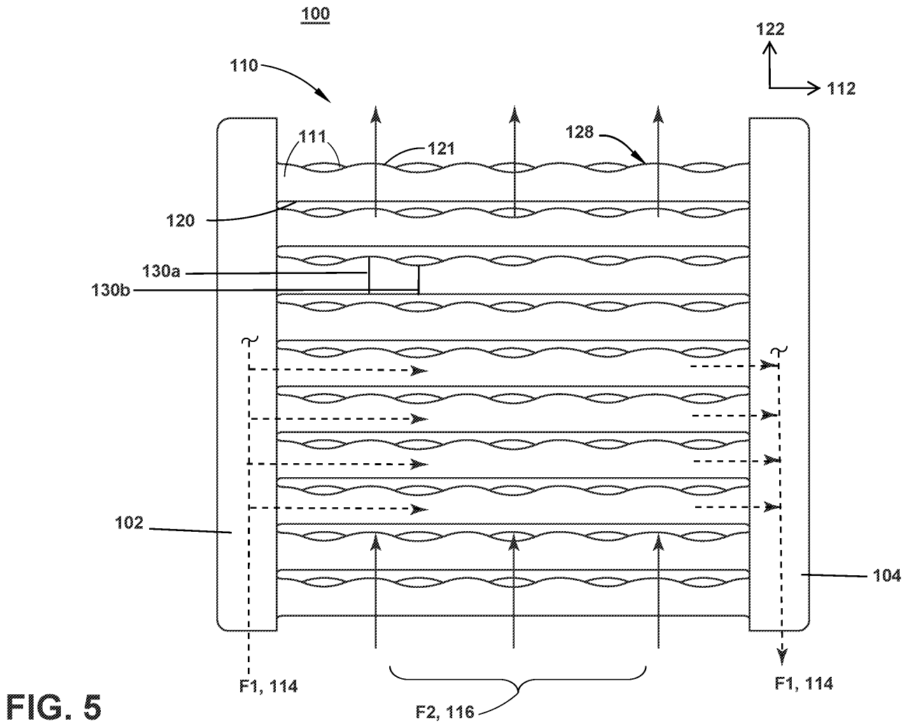

Turning now to FIG. 5, the trailing edge 121 has an undulating form 128 defined in the first direction 112. The undulating form 128 can be any repeating curved shape such as a sinusoidal geometry. Each tube 111 of the set of tubes 110 has an axial width 130 in the axial second direction. The axial width 130 varies repeatedly between a maximum 130 a and a minimum 130 b that correspond to the maximum and minimum of the undulating form 128. Because the axial width 130 of the tube 111 varies, the axial cross-sectional area 134 for each tube 111 also varies when defined along the longitudinal first direction 112. In another aspect, the maximum 130 a and minimum 130 b of the axial width 130 can be approximately the same, in which case the axial cross-sectional area 134 for each tube 111 of the set of tubes 110 is approximately uniform, or within ±10%. The cross-sectional area can be kept approximately the same while changing the major and minor dimensions of the quasi-elliptical cross-section. When kept uniform or approximately uniform, the constant cross-sectional area decreases the pressure losses through the channel and results in less turbulation. However, it should also be understood that a variable cross-sectional area is also contemplated. A variable cross-sectional area produces pulsating low and high fluid velocities, creating turbulence, resulting in a higher heat transfer coefficient, h and improved heat transfer. Thus, it should be appreciated that a balance can be struck between the constant cross-section or the variable cross-section, with having a more constant cross-section where pressure losses are more advantageous, or a more variable cross-section if local heat transfer is more advantageous. In this way, it is further contemplated that portions of the heat exchanger have different cross-sections, both varying and constant, but located separately.

Still referring to FIG. 5, a first fluid 114 flows through the first manifold 102 to enter the set of tubes 110 and follow fluid passage F1 to exit the set of tubes 110 and enter the second manifold 104. Flow path F2 crosses the outer surface of set of tubes 110 from the front to rear of the heat exchanger 100. A second fluid 116 follows flow path F2 by entering the heat exchanger 100 at the front, passing over and between the set of tubes 110 for heat exchange with the first fluid 114, and exits at the rear of the heat exchanger 100. As shown in FIG. 5, the set of tubes 110 can have a staggered alignment.

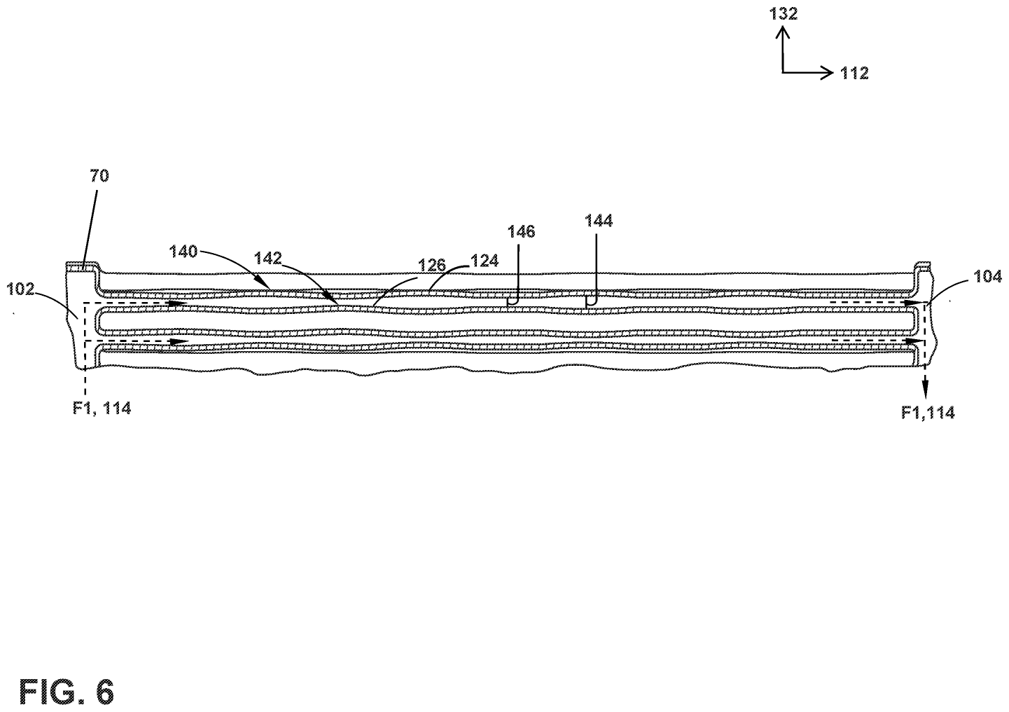

Referring now to FIG. 6, the top surface 124 can have a top profile 140 and the bottom surface 126 can have a bottom profile 142 where the top profile 140 and the bottom profile 142 are described by a regularly repeating curved geometry, such as a sinusoidal shape. The alignment of the top profile 140 and the bottom profile 142 defines thick portions 144 and thin portions 146 of the tube 111. It is contemplated that the top profile 140 can be offset from the bottom profile 142, for example by one-half of a sinusoidal period. Furthermore, the thick portions 144 align with portions of the trailing edge 121 where the axial width 130 has a maximum 130 a according to the undulating form 128, and the thin portions 146 align with portions of the trailing edge 121 where the axial width 130 has a minimum 130 b according to the undulating form 128.

The top profile 140 and the bottom profile 142 of the tube 111 can be varied to improve internal fluid mixing and minimize hydraulic loss. The shape of the set of tubes 110 is designed to include a periodic transverse velocity component to the fluid flow to increase heat transfer. The cross-sectional area 134 throughout each of the set of tubes 110 is designed can be approximately uniform to minimize velocity changes and associated hydraulic pressure losses. Such uniformity can be achieved through balancing the changes in cross-sectional area by the varying width 130 as well as the varying thicknesses of the thick and thin portions 144, 146, such that increases in thickness are aligned with decreases in width 130, or visa-versa, such that a substantially uniform cross-sectional area is achieved. The substantially uniform cross-section provides for reducing the velocity changes or pressure losses, which maintains efficiency while improving overall heat transfer.

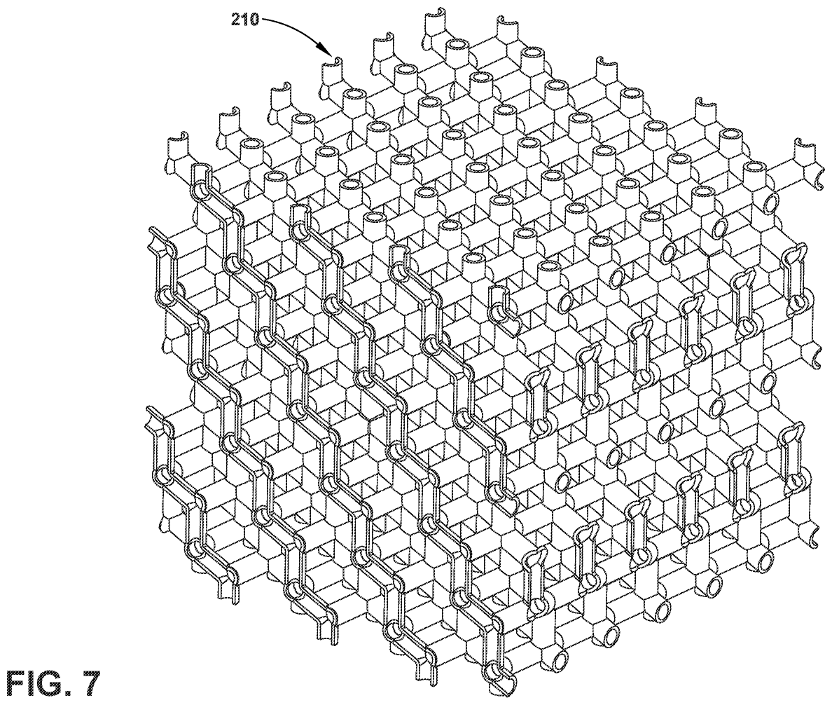

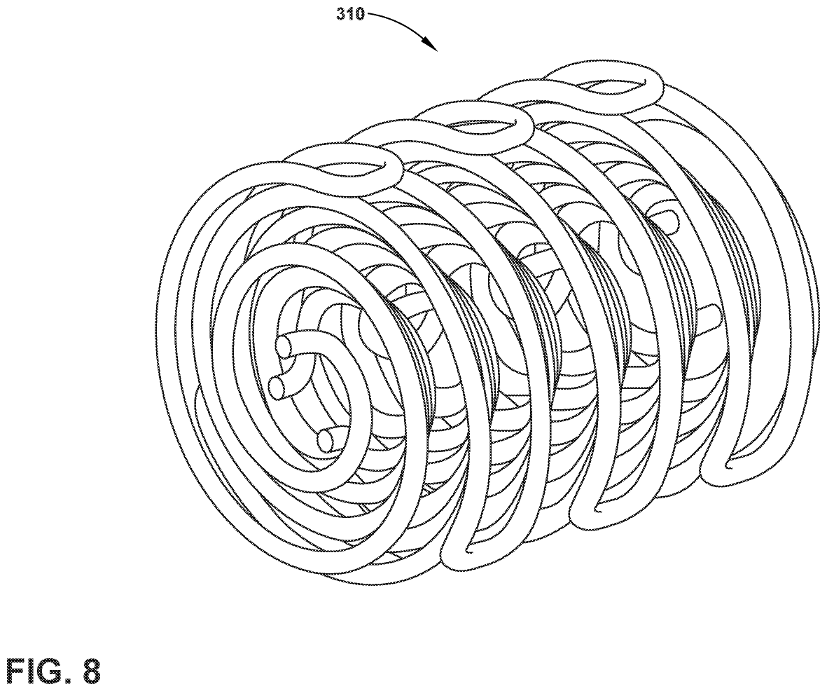

In another aspect, the fluid passages can be formed as a set of intertwined trifurcating tubes 210 as shown in FIG. 7. In the case of the trifurcating tubes 210 the junctions have a tetrahedral arrangement such that each flow path has numerous jogs. In yet another aspect, the fluid passages can be formed as a set of nested spirals 310 as shown in FIG. 8. The process 400 allows these geometrically complex structures to be formed with advantageous wall thickness, surface smoothness, low porosity and low defects, and without the need for individual sealing connections or assembly of parts by welding or brazing. The manifolds 102, 104 are joined to the fluid conduit tubes 110, 210, 310 in-situ during electrodeposition, reducing the potential for sealing defects or failure opportunities.

Benefits associated with the disclosure herein include, but are not limited to, the complex geometry and intertwined configuration of tubes which increase heat transfer, reduce fluid or aerodynamic drag, and improve structural stiffness or knockdown strength that resists high cycle fatigue. As the set of tubes 110 is integrally formed with the manifolds, there are fewer opportunities for weak points in the structure. The electroformed walls of the component being formed by the method described herein are substantially thinner than walls of components formed by other methods. The thinner walls of the component enhance heat transfer, reduce drag or hydraulic losses, and improve the structural integrity of the component. Furthermore, the improved smoothness of the component surfaces reduces the friction and improves fluid flow through the final article as reduced aerodynamic drag, flow detachment, or hydraulic losses. The reduced surface defects and reduced porosity of the electroformed component improve the strength and heat transfer properties of the component.

Further aspects of the disclosure are provided by the subject matter of the following clauses:

A method of electroforming a heat exchanger, the method comprising: polishing a conductive surface of a mandrel shaped as at least a portion of the heat exchanger, electroforming the heat exchanger onto the conductive surface of the mandrel, and removing the mandrel from the electroformed heat exchanger.

The method of any preceding clause wherein polishing the conductive surface smooths the conductive surface roughness (rms) to less than 32 microinches (0.81 micrometers, Ra=29 microinches).

The method of any preceding clause wherein electroforming the heat exchanger further includes electroforming the heat exchanger to have a wall thickness that is less than 4 mils (0.01 centimeters).

The method of any preceding clause further comprising activating the conductive surface for electroforming.

The method of any preceding clause wherein activating includes treating the conductive surface to remove contaminants.

The method of any preceding clause wherein the electroformed heat exchanger is treated along inner surfaces that are exposed when the mandrel is removed.

The method of any preceding clause wherein treating the heat exchanger includes treating the inner surfaces with an etchant.

The method of any preceding clause further comprising attaching a manifold component to the mandrel.

The method of any preceding clause further comprising metalizing the mandrel to form the conductive surface prior to polishing the conductive surface.

The method of any preceding clause further comprising forming the mandrel to shape to at least the portion of the heat exchanger prior to metalizing the mandrel.

A method of electroforming a heat exchanger, the method comprising: polishing a conductive surface of a mandrel shaped as the heat exchanger, electroforming the component onto the conductive surface of the mandrel, and removing the mandrel from the heat exchanger to expose a new surface of the component previously bordered by the mandrel, wherein the new surface has a surface roughness (rms) that is less than 32 microinches (Ra=29 microinches) resultant of polishing the conductive surface before electroforming the component.

The method of any preceding clause wherein the component further has a wall thickness that is between 3 and 4 mils.

The method of any preceding clause further comprising treating the new surface with an etchant.

The method of any preceding clause further comprising activating the conductive surface prior to electroforming by treating the conductive surface to remove contaminants.

The method of claim 11 wherein the component is made of a material that has a porosity that is less than 50 microinches.

A method of forming a heat exchanger, the method comprising: providing a removable mandrel defining the shape of the heat exchanger, coating surfaces of the mandrel in a conductive coating to define a cathode, electroforming the heat exchanger onto the cathode to include wall thicknesses that are 3-4 mils, removing the mandrel from the electroformed heat exchanger, and

treating the electroformed heat exchanger to remove any remaining conductive coating from the electroformed heat exchanger.

The method of any preceding clause further comprising polishing the conductive coating prior to electroforming.

The method of any preceding clause wherein polishing provides for creating a surface roughness (rms) for the heat exchanger that is less than 32 microinches.

The method of any preceding clause wherein electroforming further includes forming a monolithic, unitary heat exchanger including a first manifold, a second manifold, and a set of tubes coupling the first manifold to the second manifold.

The method of any preceding clause wherein treating the remaining conductive coating includes using an etchant.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new examples, whether or not the new examples are expressly described. Combinations or permutations of features described herein are covered by this disclosure. Many other possible embodiments and configurations in addition to that shown in the above figures are contemplated by the present disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of electroforming a heat exchanger, the method comprising:
polishing a conductive surface of a mandrel shaped as at least a portion of the heat exchanger;
electroforming the heat exchanger onto the conductive surface of the mandrel; and
removing the mandrel from the electroformed heat exchanger.

2. The method of claim 1 wherein polishing the conductive surface smooths the conductive surface roughness (rms) to less than 32 microinches (0.81 micrometers).

3. The method of claim 2 wherein electroforming the heat exchanger further includes electroforming the heat exchanger to have a wall thickness that is less than 4 mils (0.01 centimeters).

4. The method of claim 1 further comprising activating the conductive surface for electroforming.

5. The method of claim 4 wherein activating includes treating the conductive surface to remove contaminants.

6. The method of claim 1 wherein the electroformed heat exchanger is treated along inner surfaces that are exposed when the mandrel is removed.

7. The method of claim 6 wherein treating the heat exchanger includes treating the inner surfaces with an etchant.

8. The method of claim 1 further comprising attaching a manifold component to the mandrel.

9. The method of claim 1 further comprising metalizing the mandrel to form the conductive surface prior to polishing the conductive surface.

10. The method of claim 9 further comprising forming the mandrel to shape to at least the portion of the heat exchanger prior to metalizing the mandrel.

11. A method of electroforming a component, the method comprising:
polishing a conductive surface of a mandrel shaped as the component;
electroforming the component onto the conductive surface of the mandrel; and
removing the mandrel from the component to expose a new surface of the component previously bordered by the mandrel;
wherein the new surface has a surface roughness (rms) that is less than 32 microinches resultant of polishing the conductive surface before electroforming the component.

12. The method of claim 11 wherein the component further has a wall thickness that is between 3 and 4 mils.

13. The method of claim 11 further comprising treating the new surface with an etchant.

14. The method of claim 11 further comprising activating the conductive surface prior to electroforming by treating the conductive surface to remove contaminants.

15. The method of claim 11 wherein the component is made of a material that has a porosity that is less than 50 microinches.

16. A method of forming a heat exchanger, the method comprising:
providing a removable mandrel defining the shape of the heat exchanger;
coating surfaces of the mandrel in a conductive coating to define a cathode;
electroforming the heat exchanger onto the cathode to include wall thicknesses that are 3-4 mils;
removing the mandrel from the electroformed heat exchanger; and
treating the electroformed heat exchanger to remove any remaining conductive coating from the electroformed heat exchanger.

17. The method of claim 16 further comprising polishing the conductive coating prior to electroforming.

18. The method of claim 17 wherein polishing provides for creating a surface roughness (rms) for the heat exchanger that is less than 32 microinches.

19. The method of claim 16 wherein electroforming further includes forming a monolithic, unitary heat exchanger including a first manifold, a second manifold, and a set of tubes coupling the first manifold to the second manifold.

20. The method of claim 16 wherein treating the remaining conductive coating includes using an etchant.
